(19) United States
(12) Patent Application Publication
(10) Pub. No.: US 2005/0136897 A1
(43) Pub. Date: Jun. 23, 2005

(54) Adaptive input/ouput selection of a multimodal system

(76) Inventors: Sanigepalli V. Praveenkumar, Sunrise, FL (US); Deepak P. Ahya, Plantation, FL (US); Daniel A. Baudino, Lake Worth, FL (US)

Correspondence Address: Larry G. Brown;Motorola, Inc., Law Department, 8000 West Sunrise Boulevard, Fort Lauderdale, FL, 33322, US

(21) Appl. No.: 10/743,513

(22) Filed: Dec. 19, 2003

(51) Int. Cl. H04Q 7/20

(52) U.S. Cl. 455/414.1

(57) ABSTRACT

An electronic device such as a radio communication device (900) includes a modality manager (112) which can select input and/or output modalities (102-110) based on available bandwidth and associated cost savings to the end user. The modality manager (112) adaptively selects the modality and also can keep track of changes in operating conditions and make changes to the current modality based on the changing conditions. By having a modality manager (112) the end user is not burdened with making determinations as to which one or more modalities (102-110) are best used in a given situation.

### TECHNICAL FIELD

This invention relates in general to the field of communications, and more particularly to a radio communication device/system that can adaptively select a mode of operation.

### BACKGROUND

Communication devices such as radio communication devices (e.g., cellular telephones) are equipped with many input and/or output “modalities” (modes of communicating information with the user of the communication device) such as speech, audio, video, text messaging and still photography. Some of these radio communication devices can also operate in multiple communication systems such as Wide Area Local Area Networks (WLANs), 2.5 or 3^{rd} Generation cellular systems, Bluetooth, etc. In such complex devices, selecting the best modality/system for a certain situation becomes very important. For example, if a communication device is equipped with MPEG-4 (Moving Picture Experts Group version 4), image-based rendering and other modalities, selection of the most appropriate modality under different system conditions becomes important.

Similarly, if the communication device is equipped with voice call, SMS (Short Message Service) text messaging and video capability, selecting the best mode to use based on what needs to be transmitted and the communication system conditions (e.g., noisy channels, not enough bandwidth capability in system to support video, etc.) also becomes important. Given that changes in system performance are affected by noisy environments, changes in bandwidth capabilities, changes in cost of service, it becomes very difficult for a user to make all of these decisions alone. Thus, a need exists in the art for a communication device that can help address one or more of these problems.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a block diagram of a modality manager handling multiple input modalities in accordance with an embodiment of the invention.

FIG. 2 shows a block diagram of a modality manager handling multiple output modalities in accordance with an embodiment of the invention.

FIG. 3 shows a flow diagram highlighting a multimodal client/server environment in accordance with an embodiment of the invention.

FIG. 4 shows a flow diagram showing a messaging interface in accordance with an embodiment of the invention.

FIG. 5 shows a flow diagram highlighting a messaging interface for a handover event due to poor coverage in accordance with an embodiment of the invention.

FIG. 6 shows a flow chart of an algorithm to determine a network to use in accordance with an embodiment of the invention.

FIG. 7 shows a block diagram of an adaptive Multimodal/Multimedia system in accordance with an embodiment of the invention.

FIG. 8 shows a block diagram of a server modality manager communicating with a mobile telephone in accordance with an embodiment of the invention.

FIG. 9 shows a block diagram of a radio communication device in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

Referring to FIG. 1, there is shown a block diagram of a modality management system 100 that can be found in an electronic device such as a radio communication device. The modality management system 100 includes a Modality Manager (MM) 112 that can handle multiple input modalities 102-110. The input modalities shown include video 102, still picture 104, audio clip 106, voice 108, text 110, etc. The input modalities are typically supported by appropriate software and/or hardware found in the radio communication device that combines to generate each of the modalities. For example, the still picture input modality may be supported by a camera built-into the communication device along with the necessary software to convert the image captured into digital information that can be stored and later transmitted by the communication device.

Although specific input modalities have been illustrated, the present invention can handle any other type(s) of modalities found in a communication device such as a cellular telephone. The MM 112 of the present invention selects from amongst one or more of the input modalities 102-110 based on factors such as the currently available communication network(s), available bandwidth and those input modalities that provide the lowest cost to the end-user of the radio communication device based on the bandwidth, cost and channel conditions. The MM 112 can not only select amongst the plurality of input modalities but select from amongst different formats of a particular modality (e.g., MP3, WAV, MPEG-4, JPEG, GIF, etc.).

In accordance with an embodiment of the invention, MM 112 can automatically select one or more of the input modalities according to one or more of the following criteria: bandwidth of the system, bandwidth and service available at the moment (e.g., the radio communication device user can be currently out of range of a high data rate system and may only be able to transmit at a low data rate, the radio channel may be noisy, etc.), cost of the service (i.e., the cost of the service can be selected by the user or the service provider). Other suitable criteria can be used to select input modalities based on a particular design requirement.

Once an input modality (or modalities) is selected, the MM 112 lets the application selected by the radio communication device user such as a Multimedia Messaging Service (MMS) application 114 or a phone application 116 know what type of input(s) are acceptable. For example, to create an MMS application 114, the application can select the input according to what the MM 112 dictates; so if the MM 112 accepts only pictures, text and voice, then video and audio clips would not be allowed to be transmitted in the MMS application even if the user had selected these as part of the MMS application. This could be the case if the MM 112 determined that video could not be transmitted due to lack of bandwidth or a noisy channel situation.

The MM 112 can be implemented as a task (algorithm) operating in a microprocessor and/or microcontroller, Digital Signal Processor (DSP) or other hardware/software combination. The MM 112 will interface with the input modalities 102-110 as well as provide control to the end applications 114-116 selected by the communication device user. The MM 112 will also interface with other parts of the communication device (e.g., receiver, microphone) in order to make determinations on bandwidth availability, ambient noise issues, etc.

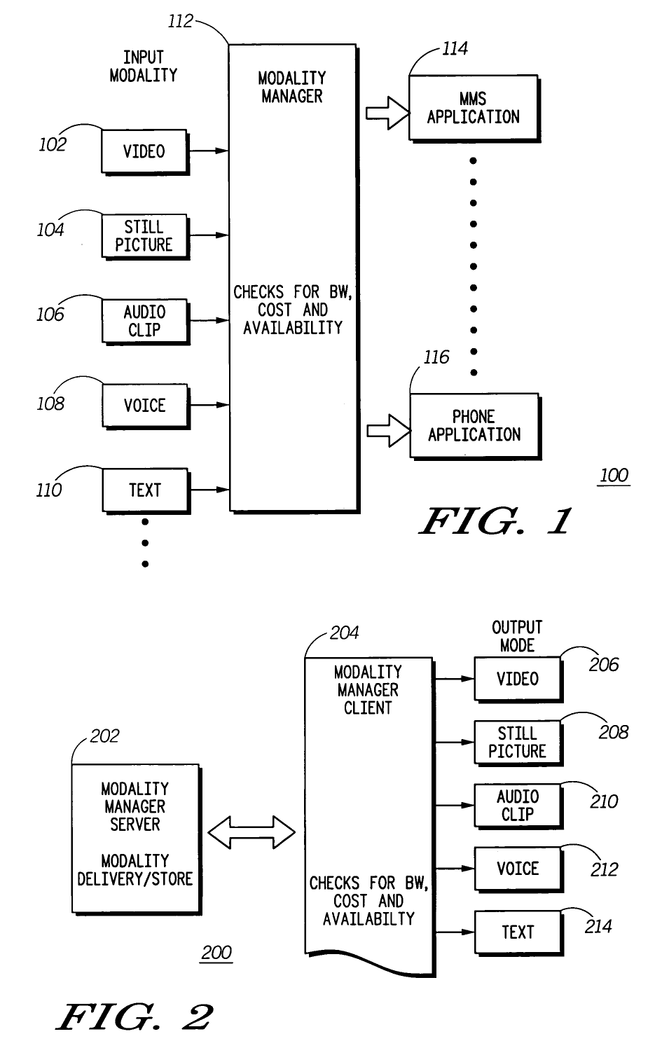

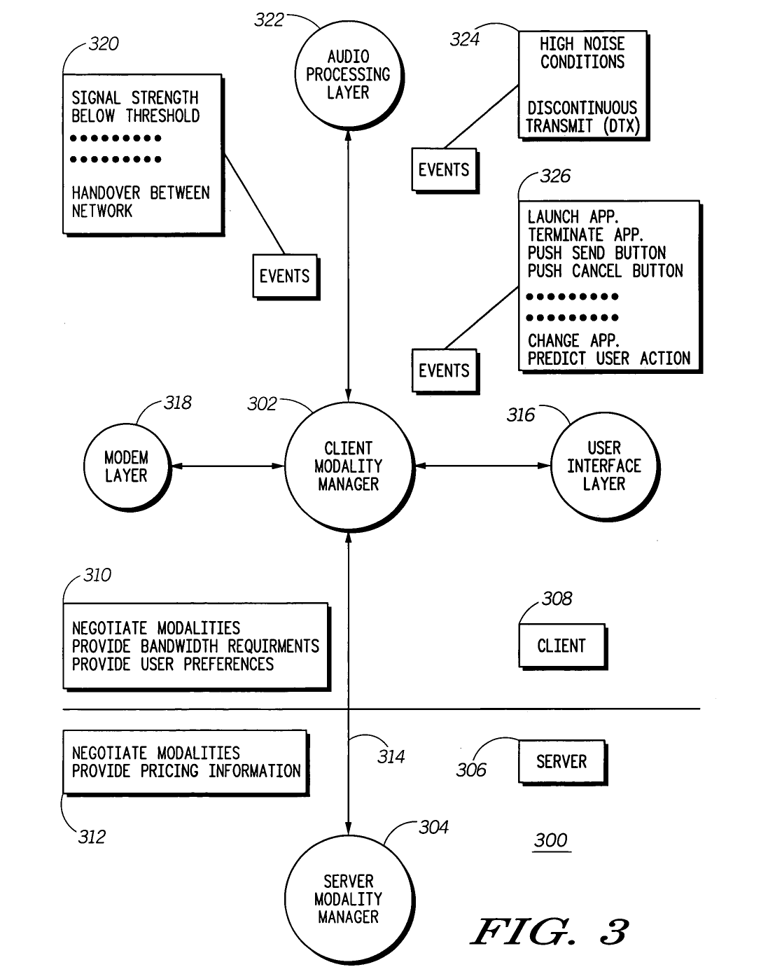

In FIG. 2, there is shown a multimodal output system 200, in this case the Modality Manager 202 is located in a server, for example a server located in a radio communication system infrastructure (e.g., system controller). A client version MM 204 resides in the client such as a mobile radio communication device. The client and the server side will automatically adapt to the kind of modality that the device can handle based on bandwidth, cost and availability. For example, if an MMS is sent to the mobile radio communication device, before it is delivered to the mobile radio, the server MM 202 will communicate with the client MM 204 and find out about the system availability with respect to bandwidth and cost of service.

Once the modality determination has been made by the server MM 202 and client MM 204, the server side MM 202 can deliver the content to the mobile radio, adapting the modality transmitted to those approved by MM 202 and MM 204. As an illustrative example, if an MMS is received at the server MM 202 that has to be forwarded to the client MM 204 and includes video, pictures, audio clips and text, only those modalities accepted by the client MM 204 will be delivered to the mobile radio, the rest can be stored in the server side MM 202 for later accessibility.

As an illustrative example, if the mobile radio just enters a system which supports high data rate service, the previously stored data that required a high data rate service (e.g., video) can be downloaded from the server MM 202 to the mobile radio (client MM 204). The mobile radio can request for the rest of the content once the client MM 204 approves it (i.e., mobile radio entering a WLAN coverage area). In one embodiment of the invention, the information stored in the server can be automatically deleted if after a predetermined period of time the mobile radio cannot still accept the information.

Selection of Appropriate Modality

When a user of a communication device such as a mobile radio equipped with a modality manager launches a communication application such as text messaging, etc. (or based on user preferences), the communication application specifies the bandwidth requirements to the MM located in the mobile radio, based on the existing information (e.g., predetermined thresholds stored in the mobile radio and/or communication system) or through messages to the mobile radio's modem layer or transmitter (depending on the mobile radio design) and obtains several available modes (e.g., video, voice, etc.) and cost for the bandwidth. In the case of unavailability of sufficient bandwidth for the communication application that has been requested, it is indicated to the communication application which then can select an alternative mode of communication. In one embodiment, the mobile radio user may be informed of the unavailability of enough bandwidth via audio and/or visual signals such as a blinking Light Emitting Diode (LED) or an audio beep.

In an illustrative example, if a mobile radio is transmitting video and audio and the channel bandwidth drops below a predetermined threshold level, then the local MM located in the mobile radio upon learning of the bandwidth problem may automatically stop transmitting video and continue to transmit the audio, instead of sending video which may not be received with very good quality images. In this example, the MM automatically switched modalities in order to maintain the quality of the transmitted information at a high level. Since the audio requires less bandwidth than the video, the mobile radio should be able to continue to transmit audio at a high level of quality, even with the bandwidth degradation. A similar automatic modality switch can occur due to cost of transmission being greater than a predetermined amount using one mode of operation. This illustrative example shows how the invention keeps a communication link operational during changes in for example bandwidth and/or cost of transmission.

The negotiation between the mobile radio's MM and the system is done until the application requirement matches with network bandwidth availability. If there is more than one choice available, the pricing information is obtained through the carrier database or via user input by the MM in the mobile radio communicating with the MM in the communication system infrastructure. The available modality choice with the lowest cost is then selected.

In another embodiment of the invention the MM can determine if sensitive data is being used by an application and use this information to select which of the modalities to use. For example, if the application selected provides a voice or audio output, the MM may restrict those modalities that provide an audio output so others may not hear the sensitive information and restrict the modalities available to those that can provide protection to the sensitive information such as text messaging. In still another embodiment, the MM can keep track of user preferences for different modalities and use this user preference information to select modalities for a particular application.

In FIG. 3, there is shown a flow diagram highlighting a multimodal client 308 and server 306 in the system 300. The client side 308 includes a client MM 302 while the server side includes a server MM 304. In this illustrative example, the client can comprise a radio communication device such as a mobile radio, while the server side 306 comprises a communication network controller or other communication system infrastructure. A user interface layer 316 which is found in the mobile radio can provide for events 326 such as launching an application (e.g., text messaging, MMS, etc.), terminating an application, changing an application etc. A modem layer 318 determines such events as signal strength being below a predetermined threshold and helps perform handovers between communication networks, etc. An audio processing layer 322 determines events 324 such as high ambient noise conditions, discontinuous transmit (DTX) conditions, etc. The audio processing layer 322 is the task that monitors and generates an event if the ambient environment of the mobile radio is too noisy. The audio processing layer 322 can be performed by a software routine that with the help of a microphone and audio processing circuitry monitors ambient noise and is preferably performed as a background task. The noise thresholds are determined and adapted based on the operating conditions of the mobile radio. If the noise level is above the predetermined threshold level, an event trigger is sent to the client MM 302. The client MM 302 can adapt the User Interface (UI) layer 316 to be text based instead of speech or other audio input that can be affected by the ambient noise. Similarly, in the case of video, if the captured video frames are too dark or too light with no contrast, the video would be considered noisy and the client MM 302 would stop sending video and have the user interface layer 316 adjust and only allow for one or more other modalities such as voice and/or text.

The audio processing layer 322, the modem layer 318 and the user interface layer 316 all interact with the client MM 302 in order to negotiate modalities, provide bandwidth requirements and provide user preferences 310 to the server 306. The server MM 304 communicates with the client MM 302 in order to negotiate modalities and provide pricing information 312. The audio processing layer 322, the modem layer 318 and the user interface layer 316 can all be comprised of software and/or hardware that can perform the required tasks.

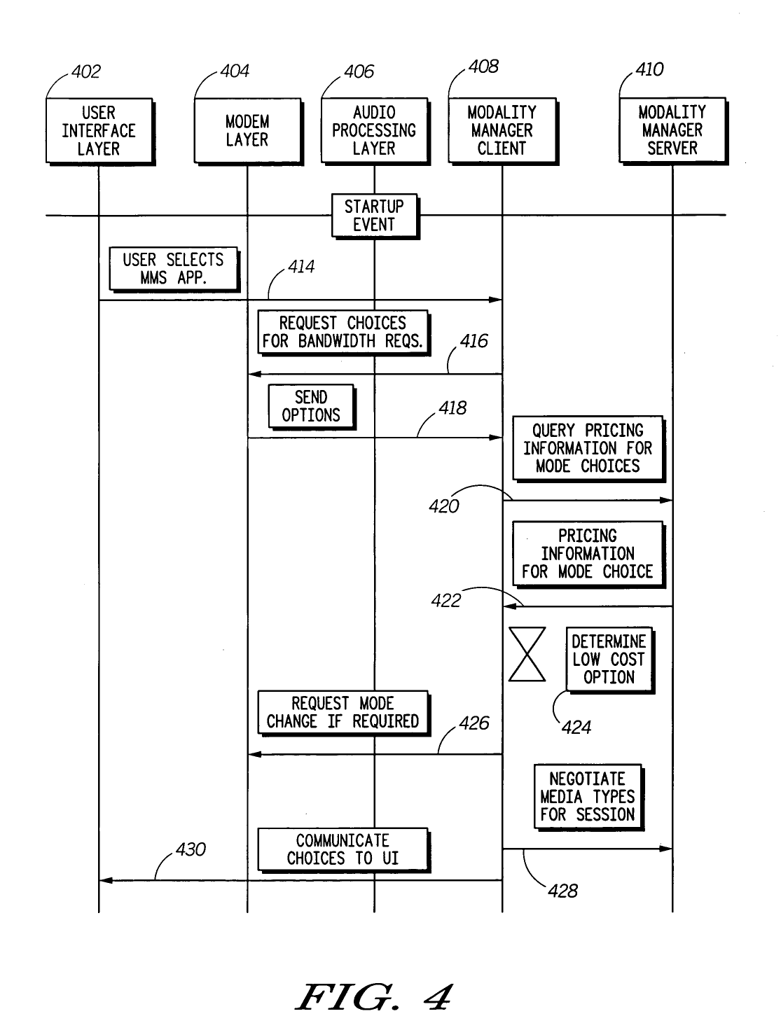

Referring now to FIG. 4, there is shown a messaging interface flow diagram for a startup event. The different system layers shown include the user interface (UI) layer 402, the modem layer 404, the audio processing layer 406, the client MM 408 and the server MM 410. Upon the electronic device (e.g., mobile radio) startup, the radio user may request an MMS application in step 414 as an illustrative example. The request for the MMS application is sent to the local client MM 408. The client MM 408 sends a message to the modem layer 404 requesting choices for bandwidth requirements in step 416. In step 418, the modem layer 404 transmits a message back to the client MM 408 that informs it of the available bandwidth options.

In step 420, the client MM 408 sends a message to the server MM 410 querying about pricing information for the different mode choices. In response, the server MM 410 sends the pricing information for the different mode choices in step 422 to the client MM 408. In step 424, the client MM 408 determines the lowest cost option and in step 426 requests a mode change if required to the modem layer 404. In step 428, the client MM 408 negotiates media types for the session with the server MM 410. Finally, in step 430, the client MM sends the available modality choices to the UI layer 402.

As shown in relation to the message flows in FIG. 4, the architecture results in an adaptive multimodal system. Events would trigger changes in the state machine.

Some events that can trigger changes can include handover due to poor coverage in the current network, availability of a lower cost network and bandwidth options, low signal to noise ratios, user preference triggers such as startup of application and time event triggers, and change in bandwidth conditions such as allocation of less bandwidth.

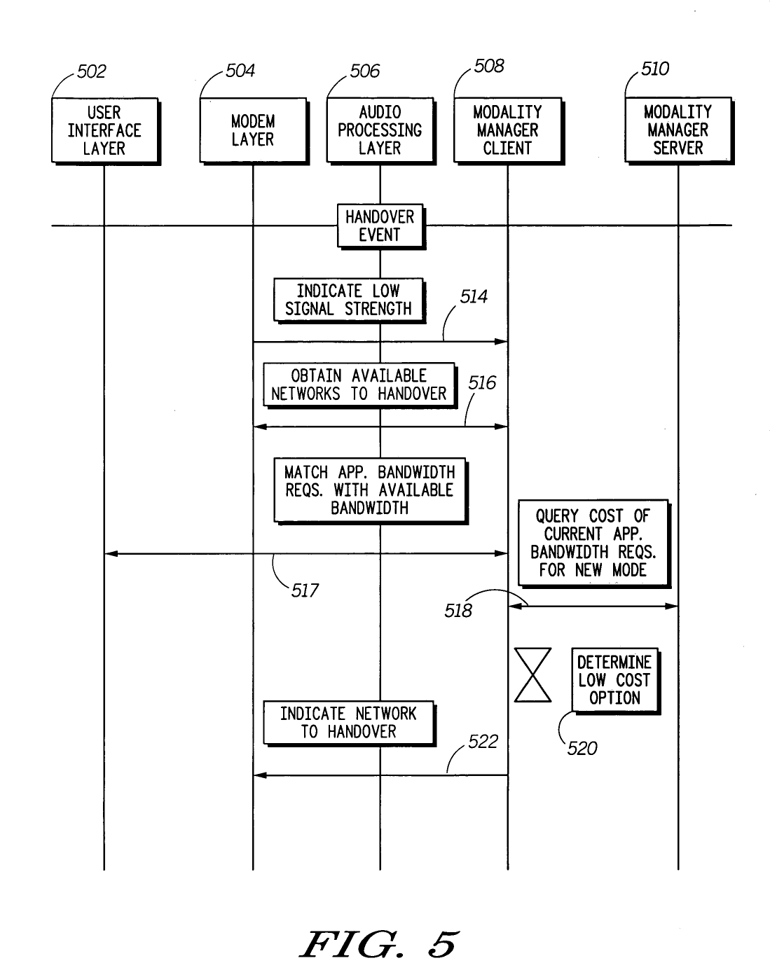

In FIG. 5, there is shown a flow diagram for a messaging interface for a handover event caused by poor reception in the current location of the client MM 508 which is part of a mobile radio. Like before, the state machine includes the user interface layer 502, the modem layer 504, the audio processing layer 506, the client MM 508 and the server MM 510 (located in the server side). In step 514, the modem layer 504 informs the client MM 508 of a low signal strength condition. In step 516, the client MM 508 requests to the modem layer 504 to obtain information on available networks to handover to. In step 517, the client side layers match the application bandwidth requirements with the available bandwidths. In step 518, the client MM 508 queries the server MM 510 about the cost of current application bandwidth requirements for a new mode. In step 520, a low cost option is determined and in step 522 the client MM 508 informs the modem layer 504 of which network to go to.

Messages between MM 508 and User Interface Layer 502 to Match Bandwidth

List below are a couple of the messages (parameter names) used between the client MM 508 and the UI layer 502 to match bandwidth requirements:

1). MM_UI_Bandwith

Description
This message sent from Multimodal manager to User Interface specifies available bandwidth
   2). UI_MM_Bandwidth

Description
This message sent from User Interface to Multimodal manager specifies the required bandwidth.

Upon handover between communication networks, “MM_UI_Bandwidth” is sent to the application. If the bandwidth fits the application requirements, an acknowledgement is received. Otherwise, the application/UI sends a “UI_MM_Bandwidth” with its requirements. Depending on the options available, the client MM 508 switches to another network. If no options are available for the application requested by the user, the application is terminated. The number of messages used will depend on the particular system design requirements and how much information needs to be shared between the local and server modality managers, etc.

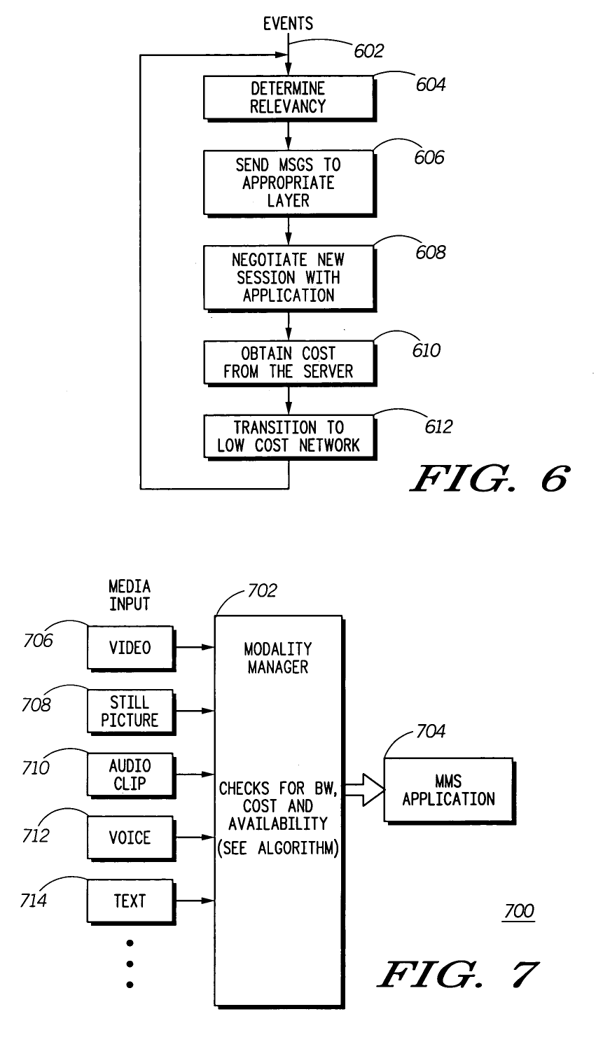

In FIG. 6 there is shown a flowchart of an illustrative example algorithm to determine which communication network to use based on bandwidth requirements and cost. In step 602 an event like a request by the user layer to send an MMS message is generated. In step 604, the relevancy of the request is made by the client MM; the client MM then sends messages to appropriate layers within the communication device in step 606. In step 608, the client MM negotiates a new session with the application. While in step 610, the client MM sends a message to the server MM to determine costs of the different available network(s) that can handle the MMS message request. After receiving the cost information, the client MM can then automatically transition the mobile radio to the lower cost network in step 612 without user intervention.

Composing an MMS

Referring to FIG. 7, there is shown a block diagram of a client MM 702 coupled to a plurality of media inputs 706-714. The media inputs shown include video 706, still picture 708, audio clip 710, voice 712, text 714, etc. In this illustrative case scenario, if an MMS application 704 is to generate an MMS message, the MM 702 selects the one or more media inputs 706-714 that will be used for the MMS message. The selection criterion is based on the bandwidth available in the network the communication device is presently in, the cost of the service (preferred network) and availability. The user of the device will only be allowed to enter those media inputs 706-714 which are permitted by the MM 702 after the MM has queried the systems server MM (not shown). Using this methodology, the electronic device user will be able to reduce his airtime costs when the available BW and condition of the communication channel is limited.

Server Modality Manager

Once the MMS message is composed and sent by the electronic device as discussed above, the system server will hold the message before sending the MMS to the designated receiver. The server modality manager will check with the local version of the modality manager of the designated receiving device and verify the type of media content the designated receiving device can accept.

Once the server and the receiving unit's MM agree on the content, the server can deliver the NMS. If the receiving unit's MM reports the non-availability of a channel/service having enough bandwidth to support the message, the server can store the MMS for later delivery, deliver the MMS with only that part of the message that can be accepted by the receiving device (e.g., text) and then check later for bandwidth availability to deliver the rest of the media content (e.g., video).

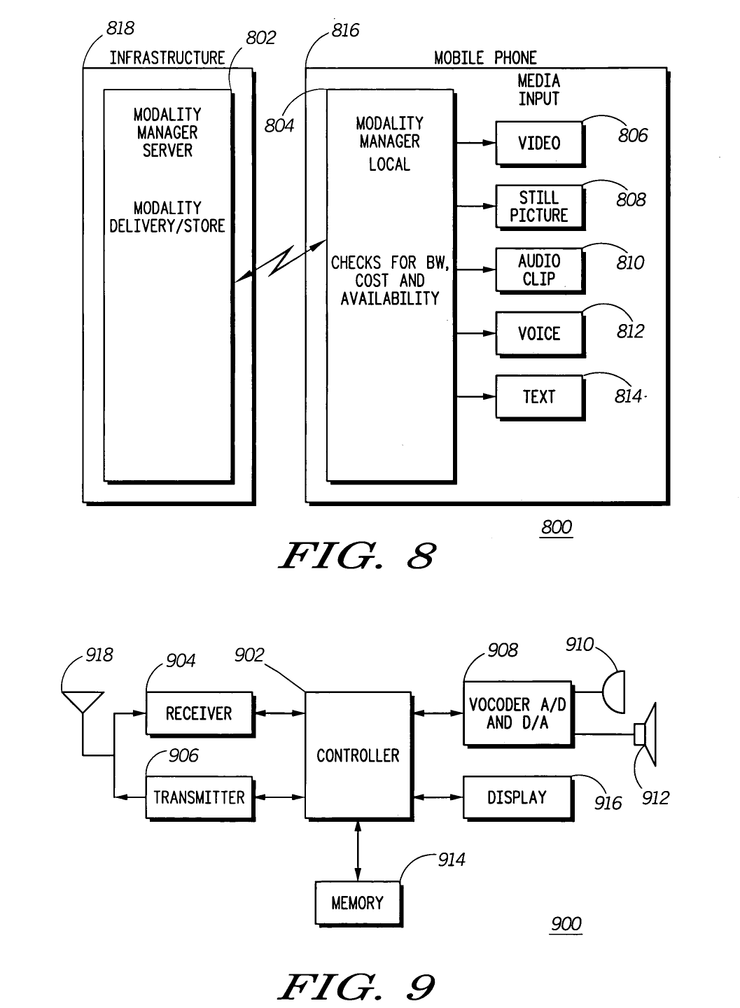

In FIG. 8, there is shown a radio communication system 800 that includes a mobile radio (phone) 816 having a local modality manager 804 and multiple media input modalities 806-814. The radio communication system infrastructure 818 includes a server modality manager 802. The present invention can be used in wireless systems like communication system 800 as well as non-wireless systems.

In FIG. 9 there is shown a block diagram of an electronic device such as a mobile radio 900 (e.g., cellular telephone) that can take advantage of the modality management system of the present invention. Cellular telephone 900 includes an antenna 918 which is selectively coupled to a conventional receiver 904 and transmitter 906 sections. A controller, such as a microprocessor, microcontroller and/or Digital Signal Processor (DSP) 902, provides the overall control for telephone 900. Memory 914 coupled to the controller 902 such as Random Access Memory (RAM), Read-Only Memory (ROM), FLASH, etc. stores all of the algorithms and variables needed by cellular telephone 900. A display 916 provides visual information to the cellular telephone user.

An audio processing block 908 which can include a vocoder and Analog-to-Digital (A/D) and Digital-to-Analog (D/A) block provides all the necessary audio processing for both incoming and outgoing voice traffic. Coupled to the audio processing block 908 is a speaker 912 and microphone 910. The audio processing layer 322 may use information gathered by the microphone 910 when making ambient noise determinations.

Controller 902 performs all of the necessary steps previously described in order to provide the adaptive multimodal system previously described. Controller 902 Memory 914 stores all of the modality information that has been received as well as store predetermined limits regarding acceptable bandwidth and noise levels as well as cost information that are used by the MM to make the necessary mode selections. The controller 902 will execute all of the necessary algorithms used by the invention in accomplishing not only the MM function but the modem layer, user interface layer and audio processing layers previously described.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for selecting one or more modalities from a group of modalities available in a communication device having a modality manager, the communication device operating in one or more communication systems, the method comprising the steps of:
(a) determining the available bandwidth;
(b) providing the bandwidth information determined in step (a) to the modality manager; and
(c) having the modality manager select the one or more modalities based on the bandwidth information.

2. A method as defined in claim 1, further comprising the steps of:
(d) determining the cost with using one or more of the modalities;
(e) providing the cost information determined in step (d) to the modality manager; and
(f) having the modality manager select the one or more modalities based on the cost and bandwidth information.

3. A method as defined in claim 1, wherein the one or more modalities comprise input modalities.

4. A method as defined in claim 3, wherein the one or more modalities include video, still pictures, audio clips, voice and text.

5. A method as defined in claim 1, wherein the one or more modalities comprise output modalities.

6. A method as defined in claim 1, wherein the modality manager dynamically adapts the one or more modalities selected in step (c) based on a change in operational conditions.

7. A method as defined in claim 6, wherein the change in operational conditions that causes the modality manager to dynamically adapt the one or more modalities selected in step (c) includes a change in the bandwidth or change in cost of the service presently being used.

8. A method as defined in claim 6, wherein the change in operational conditions that causes the modality manager to dynamically adapt the one or more modalities selected in step (c) includes a change in the current ambient noise above a predetermined threshold level.

9. A method as defined in claim 6, wherein the change in operational conditions comprises communicating sensitive information and the modality manager dynamically adapts the selected one or more modalities if any are speech or audio based modality into a text based modalities in order to protect the sensitive information from being heard by others.

10. A method as defined in claim 6, wherein the modality manager keeps track of user preferences for different modalities amongst the plurality of modalities and when the modality manager has to adapt the one or more modalities previously selected, the modality manager uses the preference information to select one or more new modalities to use.

11. A radio communication device, comprising:
a receiver; and
a modality manager coupled to the receiver, the modality manager is responsible for dynamically adapting one or more modalities being used based on bandwidth and cost considerations.

12. A radio communication device as defined in claim 11, wherein the modality manager dynamically adapts one or more modalities currently being used if the ambient noise is above a predetermined threshold.

13. A radio communication device as defined in claim 12, further comprising a microphone coupled to the modality manager, and the microphone is used to determine the ambient noise.

14. A radio communication device as defined in claim 11, wherein the one or more modalities comprise at least one of video, still pictures, audio clips, voice and text.

15. A radio communication device as defined in claim 11, wherein the radio communication device operates in a communication system having a server modality manager and the modality manager in the radio communication device communicates with the server modality manager in order to make sure that any information using a particular modality directed to the radio communication device can be supported.

16. A radio communication device as defined in claim 11, wherein the modality manager further checks for communication system availability if the radio communication device can operate in different communication systems and uses this information to dynamically adapt the one or more modalities used.

17. A radio communication device as defined in claim 11, wherein the modality manager dynamically controls which of the one or more modalities may be used with an application that is selected by the radio communication device user.

18. A radio communication device as defined in claim 11, wherein the modality manager ascertains the cost information from the communication system the radio communication device is operating in.

19. A radio communication device as defined in claim 11, further comprising a
memory coupled to the modality manager; and
wherein the modality manager ascertains the cost information from information stored in the memory.

20. A radio communication device as defined in claim 11, wherein the radio communication device comprises a cellular telephone.
